(19) United States
(12) Patent Application Publication
(10) Pub. No.: US 2012/0189778 A1
(43) Pub. Date: Jul. 26, 2012

(54) COATING METHOD USING IONIC LIQUID

(76) Inventors: Curtis H. Riewe, Manchester, CT (US); Benjamin Joseph Zimmerman, Enfield, CT (US); Mark R. Jaworowski, Glastonbury, CT (US); Xiaomei Yu, Glastonbury, CT (US)

(21) Appl. No.: 13/014,104

(22) Filed: Jan. 26, 2011

(51) Int. Cl. B05D 3/02; C25D 5/50; B05D 3/04

(52) U.S. Cl. 427/377; 427/372.2; 427/379; 427/383.7; 205/224

(57) ABSTRACT

A coating method includes depositing a coating material onto a turbine engine component using an ionic liquid that is a melt of the salt. The coating material includes aluminum. The turbine engine component is then heat treated to react with at least one element of the coating material with at least one other element to form a protective coating on the component.

### BACKGROUND

This disclosure relates to a method of forming a protective coating on an article, such as a turbine engine component.

Components that operate at high temperatures and under corrosive environments often include protective coatings. As an example, turbine engine components often include ceramic, aluminide, or other types of protective coatings. Chemical vapor deposition is one technique for forming such coatings and involves pumping multiple reactive coating species into a chamber. The coating species react or decompose on the components in the chamber to produce the protective coating.

### SUMMARY

An exemplary coating method includes depositing a coating material onto a turbine engine component using an ionic liquid. The coating material includes aluminum. The turbine engine component is then heat treated to react at least one element of the coating material with at least one other element to form a protective coating on the component.

In another aspect, a coating method includes depositing a coating material onto a nickel alloy substrate using an ionic liquid. The coating material includes a metal or metals selected from nickel, cobalt, chromium, aluminum, yttrium, hafnium and silicon.

### BRIEF DESCRIPTION OF THE DRAWINGS

The various features and advantages of the disclosed examples will become apparent to those skilled in the art from the following detailed description. The drawings that accompany the detailed description can be briefly described as follows.

FIG. 1 shows an example coating method for depositing a coating material using an ionic liquid.

FIG. 2 illustrates another example coating method for depositing a coating material using an ionic liquid.

### DETAILED DESCRIPTION OF THE PREFERRED EMBODIMENT

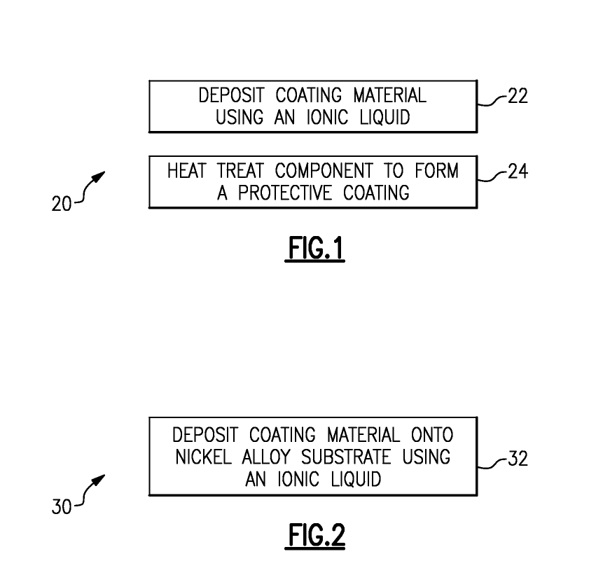

FIG. 1 illustrates an example coating method 20 that may be used to fabricate an article with a protective coating, such as a turbine engine component. A few example components are vanes or vane doublets, disks, blades, combustor panels, and compressor components. In the illustrated example, the coating method 20 generally includes a deposition step 22 and heat treatment step 24. It is to be understood that the examples herein may be used in combination with other fabrication processes, techniques, or steps for the particular component that is being coated.

The method 20 includes the use of an ionic liquid that is a melt of a salt to deposit a coating material onto the component. Unlike electrolytic processes that utilize aqueous solutions to deposit coatings, the disclosed coating method 20 utilizes a non-aqueous, ionic liquid for deposition of the coating material, such as by electrodeposition. Thus, at least some metallic elements that cannot be deposited using aqueous solutions may be deposited onto the subject component using the ionic liquid. The use of the ionic liquid also provides the ability to coat complex, non-planar surfaces, such as airfoils.

The coating material that is deposited includes aluminum metal. In that regard, the ionic liquid includes aluminum, such as a salt of aluminum. The aluminum salt may be aluminum chloride.

The ionic liquid may be used in an electrodeposition process and in combination with a consumable anode made of aluminum. Generally, the electrodeposition process involves an electrolytic technique of establishing an electric potential between the consumable anode and the component to be coated. The ionic liquid may be maintained at a predetermined temperature, such as from approximately 72° F.-212° F. (23° C.-100° C.). In one example, the ionic liquid bath is maintained at a temperature of approximately 185° F.-203° F. (85° C.-95° C.). The selected temperature facilitates lowering the viscosity of the ionic liquid and producing a generally higher conductivity.

The ionic liquid dissolves the consumable anode under the established conditions of the ionic liquid bath in which the component is submerged. The aluminum in the ionic liquid deposits onto the surfaces of the component. As an example, the rate at which the ionic liquid dissolves (consumes) the consumable anode is approximately equivalent to the rate at which the aluminum deposits onto the component. The concentration of the aluminum within the ionic liquid thereby remains steady and provides the ability to control the deposition process with regard to the deposited thickness of the coating material.

For a component that is made of a nickel-based alloy or a cobalt-based alloy, one ionic liquid that is useful for producing a steady state with regard to the deposition and consumption of aluminum is methylimidazolium chloride. In a further example, the ionic liquid may include 1-ethyl-3-methylimidazolium chloride, 1-butyl-3-methylimidazolium chloride, 1-butyl-1-methylpyrrolidinium bis(trifluoromethylsulfonyl) amide, 1-ethyl-3-methylimidazolium bis(trifluoromethylsulfonyl) amide, trihexyl-tetraadecyl phosphonium bis(trifluoromethylsulfonyl) amide or mixtures thereof.

In the method 20, the ionic liquid can be used to deposit a single metal, such as aluminum, or to co-deposit aluminum and at least one other metal. In the case of electrodeposition of the single element of aluminum, the consumable anode of aluminum and/or aluminum salt added to the ionic liquid may serve as the sources of aluminum. In another embodiment in which an additional metal or metals are to be co-deposited with the aluminum by electrodeposition, the consumable anode may also include the additional metal or metals that are to be co-deposited such that the anode has an equivalent composition to the deposited coating material in terms of the kinds of metals present. Additional metals may include one or more of hafnium, platinum, nickel, cobalt, chromium, silicon and yttrium.

As an alternative to providing the metal or metals via the consumable anode, the metal or metals may instead be added to the ionic liquid in salt form. For instance, hafnium metal, platinum metal or combinations thereof may be co-deposited with the aluminum by adding hafnium chloride and/or platinum chloride to the ionic liquid. The hafnium and/or platinum thereby co-deposit with the aluminum metal onto the component. Likewise, salts of nickel, cobalt, chromium, hafnium, silicon and/or yttrium may be added to the ionic liquid for co-deposition with aluminum.

In embodiments, the protective coating may include one or more elements of nickel, cobalt, chromium, hafnium, silicon and yttrium in combination with aluminum. For instance, the protective coating may be MCrAlY, where M is nickel and/or cobalt. The MCrAlY protective coating may serve as a bond coat for an overlayer of ceramic material that is used as a thermal barrier. The protective coating may thereby function to adhere the overlayer ceramic coating to the underlying alloy of the component.

After deposition of the coating material onto the component, the heat treatment step 24 is used to react at least one element of the coating material with at least one other element to thereby form the protective coating on the component. In an example where aluminum metal is deposited as the sole metal onto the component, the heat treatment step 24 is used to react the aluminum with at least one element of the base alloy of the component.

In embodiments, the heat treatment step 24 includes a dual-step process whereby the component is first heated at a relatively low temperature followed by heating at a relatively high temperature. The lower temperature is below the melting point of aluminum and diffuses the base element (nickel or cobalt) from the component base alloy into the coating material to form aluminum-rich base element-aluminum intermetallic phases that have a higher melting point than aluminum. The higher temperature diffuses aluminum from the intermetallic phases into the base alloy and/or the base element from the base alloy into the intermetallic phases to form a beta base element-aluminum phase in the protective coating.

In embodiments where the base alloy of the component is a nickel alloy, the lower heat treatment temperature may be approximately 1200° F. (649° C.) and the higher heat treatment temperature may be approximately 1975° F. (1079° C.). The heat treatment time may vary, depending upon the desired degree of diffusion and reaction of the aluminum metal, for example. The heat treatment may also be conducted in an atmosphere containing argon gas, an evacuated atmosphere and/or a reducing atmosphere containing hydrogen.

In another embodiment in which the coating material includes aluminum and one or more other metals, such as hafnium and/or platinum, the heat treatment step 24 may be used to react the aluminum, hafnium and/or platinum with each other or with elements from the base alloy of the component.

In another embodiment, the deposition step 22 may be used to deposit individual layers of the metals, which are then inter-diffused and reacted during the heat treatment step 24. For instance, a layer of aluminum metal may first be deposited onto the component followed by a layer or layers of hafnium and/or platinum. The heat treatment step 24 is then used to inter-diffuse the aluminum, hafnium and/or platinum and react these elements with each other or with elements from the base alloy.

Similarly, the elements of the MCrAlY coating may be deposited as individual layers on the component and subsequently diffused in the heat treatment step 24, although in this case co-deposition of the elements may result in greater homogeneity. Likewise, several layers of different composition may be deposited to form a multilayer protective coating that is compositionally graded. As an example, a first layer near the surface of the component may have a composition that reduces degradation of the base alloy of the component. A second layer that is farther in proximity from the component than the first layer may have a different composition that is better for resisting oxidation (relative to the first layer). The objectives of reducing degradation and resisting oxidation typically call for competing compositions. The compositionally graded multilayer protective coating may thereby better serve these objectives.

In some examples, at least the aluminum layer is deposited in the deposition step 22 using the ionic liquid and one or more subsequent layers are deposited using other techniques, such as standard aqueous electrodeposition or chemical vapor deposition techniques.

FIG. 2 shows another example method 30 that is somewhat similar to the method 20 of FIG. 1 but does not necessarily include the heat treatment step 24. In this example, a deposition step 32 includes depositing the coating material onto a nickel alloy (e.g., by electrodeposition as described above), such as a nickel alloy in the form of a turbine engine component, using the ionic liquid. The as-deposited coating material constitutes the protective coating without further heat treatment. For instance, the MCrAlY coating as described above may be deposited onto the substrate using the ionic liquid and the resulting coating may be a stand alone protective coating or a bond coat for the further deposition of a ceramic overlay coating as described above. In some examples however, it may be desirable to further treat the coating via heat treatment to produce an oxidize scale for corrosion protection and/or enhanced adhesion of overlayer coatings.

In another embodiment, the deposition steps 22 or 32 may be used to deposit multiple layers of different compositions. For instance, the deposition steps 22 or 32 may be used to deposit first and second layers of MCrAlY having different amounts of the constituent elements. As an example, the chemistry of the bath with regard to the ionic liquid, consumable anode and/or added salts may be designed to deposit the first layer. The bath may then be altered, or a separate bath used, to deposit the second layer on the first layer. Subsequent layers may be deposited in the same manner.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A coating method comprising:
depositing a coating material onto a turbine engine component using an ionic liquid that is a melt of a salt, and the coating material includes aluminum; and
heat treating the turbine engine component to form a protective coating on the turbine engine component.

2. The method as recited in claim 1, wherein the heat treating reacts at least one element of the coating material with at least one other element to form the protective coating.

3. The method as recited in claim 1, wherein the turbine engine component comprises a nickel-based alloy or a cobalt-based alloy.

4. The method as recited in claim 1, wherein the depositing of the coating material includes co-depositing at least one other metal element, in addition to the aluminum, onto the turbine engine component using the ionic liquid.

5. The coating method as recited in claim 4, wherein the at least one other metal element is selected from a group consisting of hafnium, platinum and combinations thereof.

6. The method as recited in claim 4, wherein the at least one other metal element is selected from a group consisting of nickel, cobalt, chromium, yttrium, hafnium, silicon and combinations thereof.

7. The method as recited in claim 1, wherein the ionic liquid comprises methylimidazolium chloride.

8. The method as recited in claim 7, wherein the ionic liquid comprises aluminum chloride.

9. The method as recited in claim 1, wherein the ionic liquid includes a substance selected from a group consisting of 1-butyl-3-methylimidazolium chloride, 1-butyl-1-methylpyrrolidinium bis(trifluoromethylsulfonyl) amide, 1-ethyl-3-methylimidazolium bis(trifluoromethylsulfonyl) amide, trihexyl-tetraadecyl phosphonium bis(trifluoromethylsulfonyl) amide and mixtures thereof.

10. The method as recited in claim 1, wherein the depositing of the coating material includes the consumption of an anode having an equivalent composition to the protective coating.

11. The method as recited in claim 1, wherein the heat treating includes heating the turbine engine component at a first temperature for a first amount of time followed by heating the turbine engine component at a second, greater temperature for a second amount of time.

12. The method as recited in claim 11, including heat treating the turbine engine component in at least one of an atmosphere containing argon gas, an evacuated atmosphere, and a reducing atmosphere containing hydrogen.

13. The method as recited in claim 1, wherein the depositing of the coating material includes depositing a first layer of a first composition and a second layer of a second, different composition.

14. The method as recited in claim 13, wherein the first layer is aluminum and the second layer is selected from a group consisting of hafnium, platinum and combinations thereof.

15. The method as recited in claim 1, wherein the depositing of the coating material includes adding a salt of a metal that is to be deposited as the coating material into the ionic liquid.

16. The method as recited in claim 1, wherein the protective coating is a multilayer protective coating that is compositionally graded.

17. The method as recited in claim 1, wherein the depositing of the coating material is by electrodeposition.

18. A coating method comprising:
depositing a coating material onto a nickel alloy substrate using an ionic liquid that is a melt of a salt, and the coating material includes a metal or metals selected from a group of nickel, cobalt, chromium, aluminum, yttrium, hafnium and silicon.

19. The method as recited in claim 18, wherein the nickel alloy substrate is a turbine engine component.

20. The method as recited in claim 18, wherein the coating material includes chromium, aluminum, yttrium and at least one of nickel and cobalt.
